(19) United States
(12) Patent Application Publication
(10) Pub. No.: US 2023/0347621 A1
(43) Pub. Date: Nov. 2, 2023

(54) BI-DIRECTIONALLY ORIENTED POLYETHYLENE FILM

(71) Applicant: SABIC GLOBAL TECHNOLOGIES B.V., BERGEN OP ZOOM (NL)

(72) Inventors: Niclasina Siberta Johanna Alberdina Gerrits, Sittard (NL); Attilio Scala, Maastricht (NL)

(21) Appl. No.: 17/791,337

(22) PCT Filed: Dec. 29, 2020
(86) PCT No.: PCT/EP2020/087951

§ 371 Date: Jul. 7, 2022

(30) Foreign Application Priority Data
Jan. 13, 2020 (EP) 20151455.1

(51) Int. Cl. B32B 7/03; B32B 27/08; B32B 27/32; B32B 38/00; B32B 37/06; B32B 37/15

(52) U.S. Cl. CPC B32B 7/03; B32B 27/08; B32B 27/32; B32B 38/0012; B32B 37/06; B32B 37/153; B32B 2307/72; B32B 2307/7376; B32B 2250/03; B32B 2439/70; B32B 2038/0028; B32B 2038/0068

(57) ABSTRACT

The present invention relates to a film comprising one or more layers, wherein at least one layer consists of a polymer formulation (A) comprising:
(c) ≥60.0 and ≤90.0 wt % of a linear low-density polyethylene; and
(d) ≥10.0 and ≤40.0 wt % of a high-density polyethylene
with regard to the total weight of that layer of the film,
   wherein the film is a bi-directionally oriented film wherein the orientation is introduced in the solid state. Such film has improved tensile properties, such as demonstrated by improved tensile modulus in both machine direction as well as in transverse direction, and improved tensile strength, also in both machine direction and in transverse direction. Such film also has desirable optical properties and impact properties, and has good thermal resilience. Furthermore, by that components (a) and (b) are both polymers of the polyethylene family, the film has good recyclability properties.

### CROSS REFERENCE TO RELATED APPLICATIONS

This application is a National Stage application of PCT/EP2020/087951, filed Dec. 29, 2020, which claims the benefit of European Application No. 20151455.1, filed Jan. 13, 2020, both of which are incorporated by reference in their entirety herein

### BACKGROUND

The present invention relates to a bi-directionally oriented polyethylene film comprising a linear low-density polyethylene. The invention also relates to a process for the production of such film. The invention further relates to the use of such film in packaging applications such as food packaging applications. In particular, the invention relates to a film having improved mechanical properties.

Films comprising linear low-density polyethylene are abundantly used in a wide variety of applications. A particular example where such films find their application is in food packaging. Use of such films allows for packaging of foodstuff products in a very hygienic manner, contributes to preservation of the packaged products for a prolonged period, and can be done in a very economically attractive way. Further, such films can be produced with a highly attractive appearance.

A particular type of films that may be produced using linear low-density polyethylenes are biaxially oriented films wherein the orientation is introduced in the solid state, also referred to commonly as bi-directionally oriented films or BO films. BO films are widely used in for example food packaging applications. Such BO films may for example be produced by sequential or simultaneous stretching of a film produced by cast extrusion in both the longitudinal direction, also referred to as machine direction, and the transverse direction of the film. By so, a film can be produced with high modulus and strength, thus enabling down-gauging of the film, which is one of the main drivers in the packaging industry, as is contributes to reduction of weight of the package, and material consumption. In addition, such films are processable reliably at very high processing speeds in packaging lines.

An exemplary description of the production of BO films can for example be found in WO03/059599-A1, describing a method of production of BO films using a so-called tenter frame, wherein the film, subsequent to production via cast extrusion, is subjected to stretching in the machine direction via operation of various rolls that exert a stretching force onto the cast film as a result of the selected speed of the cooperating rolls, and wherein subsequently the film is subjected to an orientation force in the transverse direction.

In many applications of BO films, it is required that the film has certain defined mechanical properties, in order to allow a package to be produced that is sufficiently strong and durable, has an appealing perception, and that allows for the product to have its desired shelf-life. Also, the package needs to withstand circumstances that it is subjected to during logistics and transportation.

In order for a film to meet such requirements, specifications are typically set for certain properties, including tensile properties, optical properties, impact properties, and thermal resilience properties. Furthermore, it is desired that such film is as thin as possible, in order to save packaging weight and thereby reduce consumption of material resources. Another aspect that is increasingly important in the field of packaging materials is its design for recyclability, which relates to the selection of certain materials in a package that increase the suitability for the material to be recycled. For example, the use of material from only a single family of polymer materials, also referred to as a ‘mono-material solution’ contributes to the recyclability of such package. In the present context, different types of polyethylenes such as linear low-density polyethylene, high-density polyethylene, and low-density polyethylene all are understood to form part of a single family of polymer materials, namely the polyethylenes.

### SUMMARY

Accordingly, there is a demand to improve the properties of BO films comprising linear low-density polyethylene, in particular to improve their tensile properties, whilst maintaining further properties, such as optical properties, impact properties and thermal resilience at desirably high level. Particularly, it is desired that such solution would not add to the weight of the package, and that it not detrimentally affects that recyclability of the package.

This has now been achieved according to the present invention by a film comprising one or more layers, wherein at least one layer consists of a polymer formulation (A) comprising:
(a) ≥60.0 and ≤90.0 wt % of a linear low-density polyethylene (LLDPE); and
(b) ≥10.0 and ≤40.0 wt % of a high-density polyethylene (HDPE)
with regard to the total weight of that layer of the film
wherein the film is a bi-directionally oriented film wherein the orientation is introduced in the solid state.

Such film demonstrates to have improved tensile properties, such as demonstrated by improved tensile modulus in both machine direction as well as in transverse direction, and improved tensile strength, also in both machine direction and in transverse direction. Such film demonstrates desirable optical properties and impact properties, and has good thermal resilience. Furthermore, by that components (a) and (b) are both polymers of the polyethylene family, the film has good recyclability properties.

### DETAILED DESCRIPTION

The polymer formulation (A) may for example comprise ≥60.0 and ≤90.0 wt % of the LLDPE, preferably ≥65.0 and ≤90.0 wt % of the LLDPE, more preferably ≥65.0 and ≤85.0 wt % of the LLDPE, even more preferably ≥70.0 and ≤85.0 wt % of the LLDPE.

The polymer formulation (A) may for example comprise ≥15.0 and ≤40.0 wt % of the HDPE, preferably ≥15.0 and ≤35.0 wt % of the HDPE, more preferably ≥15.0 and ≤30.0 wt % of the HDPE, even more preferably ≥20.0 and ≤30.0 wt % of the HDPE.

The polymer formulation (A) may for example comprise
≥60.0 and ≤90.0 wt % of the LLDPE, preferably ≥65.0 and ≤90.0 wt % of the LLDPE, more preferably ≥65.0 and ≤85.0 wt % of the LLDPE, even more preferably ≥70.0 and ≤85.0 wt % of the LLDPE; and/or
≥15.0 and ≤40.0 wt % of the HDPE, preferably ≥15.0 and ≤35.0 wt % of the HDPE, more preferably ≥15.0 and ≤30.0 wt % of the HDPE, even more preferably ≥20.0 and ≤30.0 wt % of the HDPE.

In certain embodiments of the invention, the polymer formulation (A) comprises only the LLDPE and the HDPE as polymeric materials in the formulation. The formulation (A) may for example comprise up to 5.0 wt % of additives, for example anti-block agents, slip agents, UV stabilisers, antioxidants, and processing aids.

In certain embodiments of the invention, the polymer formulation (A) consists of the linear low-density polyethylene (LLDPE) and the high-density polyethylene (HDPE).

The linear low-density polyethylene may for example have:
a density of ≥910 and ≤930 kg/m³ as determined in accordance with ASTM D792 (2008);
a melt mass-flow rate of ≥0.5 and ≤5.0 g/10 min as determined in accordance with ASTM D1238 (2013) at a temperature of 190° C. under a load of 2.16 kg;
a fraction that is eluted in analytical temperature rising elution fractionation (a-TREF) at a temperature ≤30.0° C. of ≥3.0 wt %, with regard to the total weight of the LLDPE; and/or
a fraction eluted in a-TREF at a temperature >94.0° C. of ≥20.0 wt %, with regard to the total weight of the LLDPE.

The linear low-density polyethylene may for example have a density of ≥910 and ≤930 kg/m³, preferably of ≥915 and ≤925 kg/m³, more preferably of ≥918 and ≤922 kg/m³, as determined in accordance with ASTM D792 (2008).

The linear low-density polyethylene may for example have a melt mass-flow rate of ≥0.5 and ≤5.0 g/10 min, preferably of ≥0.8 and ≤4.0 g/10 min, more preferably of ≥1.0 and ≤3.5 g/10 min, or of ≥1.5 and ≤3.5 g/10 min, as determined in accordance with ASTM D1238 (2013) at a temperature of 190° C. under a load of 2.16 kg.

The linear low-density polyethylene may for example have a fraction that is eluted in analytical temperature rising elution fractionation (a-TREF) at a temperature ≤30.0° C. of ≥4.0 wt %, preferably ≥8.0 wt %, more preferably ≥10.0 wt %, even more preferably ≥11.0 wt %, with regard to the total weight of the LLDPE. The linear low-density polyethylene may for example have a fraction that is eluted in analytical temperature rising elution fractionation (a-TREF) at a temperature ≤30.0° C. of ≥3.0 wt % and ≤16.0 wt %, preferably ≥8.0 wt % and ≤16.0 wt %, more preferably ≥9.0 wt % and ≤14.0 wt %, or ≥4.0 wt % and ≤14.0 wt %, even more preferably ≥10.0 wt % and ≤14.0 wt %, with regard to the total weight of the LLDPE.

The linear low-density polyethylene may for example have a fraction eluted in a-TREF at a temperature >94.0° C. of ≥20.0 wt %, with regard to the total weight of the LLDPE. More preferably, the LLDPE has a fraction eluted >94.0° C. of ≥25.0 wt %, even more preferably ≥30.0 wt %, yet even more preferably ≥35.0 wt %. Preferably, the fraction that is eluted in a-TREF at a temperature >94.0° C. is ≥20.0 and ≤50.0 wt %, more preferably ≥25.0 and ≤45.0 wt %, even more preferably ≥30.0 and ≤40.0 wt %, with regard to the total weight of the LLDPE.

Preferably, the fraction that is eluted in a-TREF at a temperature >30.0 and ≤94.0° C. is ≥40.0 and ≤70.0 wt %, more preferably ≥40.0 and ≤67.0 wt %, even more preferably ≥45.0 and ≤67.0 wt %, with regard to the total weight of the LLDPE.

The fraction that is eluted at a temperature of ≤30° C. may in the context of the present invention be calculated by subtracting the sum of the fraction eluted >94° C. and the fraction eluted >30° C. and ≤94° C. from 100%, thus the total of the fraction eluted ≤30° C., the fraction eluted >30° C. and ≤94° C. and the fraction eluted >94° C. to add up to 100.0 wt %.

According to the invention, analytical temperature rising elution fractionation, also referred to as a-TREF, may be carried out using a Polymer Char Crystaf-TREF 300 equipped with stainless steel columns having a length of 15 cm and an internal diameter of 7.8 mm, with a solution containing 4 mg/ml of sample prepared in 1,2-dichlorobenzene stabilised with 1 g/l Topanol CA (1,1,3-tri(3-tert-butyl-4-hydroxy-6-methylphenyl)butane) and 1 g/l Irgafos 168 (tri(2,4-di-tert-butylphenyl) phosphite) at a temperature of 150° C. for 1 hour. The solution may be further stabilised for 45 minutes at 95° C. under continuous stirring at 200 rpm before analyses. For analyses, the solution was crystallised from 95° C. to 30° C. using a cooling rate of 0.1° C./min. Elution may be performed with a heating rate of 1° C./min from 30° C. to 140° C. The set-up may be cleaned at 150° C. The sample injection volume may be 300 μl, and the pump flow rate during elution 0.5 ml/min. The volume between the column and the detector may be 313 μl. The fraction that is eluted at a temperature of ≤30.0° C. may in the context of the present invention be calculated by subtracting the sum of the fraction eluted >30.0° C. from 100%, thus the total of the fraction eluted ≤30.0° C., and the fraction eluted >30.0° C. to add up to 100.0 wt %.

Particularly, a-TREF may be carried out using a Polymer Char Crystaf-TREF 300 using a solution containing 4 mg/ml of the polymer in 1,2-dichlorobenzene, wherein the solution is stabilised with 1 g/l 1,1,3-tri(3-tert-butyl-4-hydroxy-6-methylphenyl)butane and 1 g/l tri(2,4-di-tert-butylphenyl) phosphite) at a temperature of 150° C. for 1 hour, and further stabilised for 45 minutes at 95° C. under continuous stirring at 200 rpm, wherein the prior to analyses the solution is crystallised from 95° C. to 30° C. using a cooling rate of 0.1° C./min, and elution is performed at a heating rate of 1° C./min from 30° C. to 140° C., and wherein the equipment has been cleaned at 150° C.

The high-density polyethylene may for example have:
a density of ≥945 and ≤975 kg/m³, preferably of ≥960 and ≤975 kg/m³, as determined in accordance with ASTM D792 (2008); and/or
a melt mass-flow rate of ≥3.0 and ≤15.0 g/10 min, as determined in accordance with ASTM D1238 (2013) at a temperature of 190° C. under a load of 2.16 kg.

For example, the high-density polyethylene may have a density of ≥945 and ≤975 kg/m³ as determined in accordance with ASTM D792 (2008), preferably of ≥950 and ≤975 kg/m³, more preferably of >960 and ≤975 kg/m³, even more preferably of ≥965 and ≤975 kg/m³.

For example, the high-density polyethylene may have a melt mass-flow rate of ≥3.0 and ≤15.0 g/10 min, as determined in accordance with ASTM D1238 (2013) at a temperature of 190° C. under a load of 2.16 kg, preferably of ≥3.0 and ≤12.0 g/10 min, more preferably of ≥5.0 and ≤12.0 g/10 min, even more preferably of ≥5.0 and ≤10.0 g/10 min.

For example, the LLDPE may have a density of ≥910 and ≤930 kg/m³, preferably of ≥915 and ≤925 kg/m³, more preferably of ≥918 and ≤922 kg/m³, as determined in accordance with ASTM D792 (2008), and the HDPE may have a density of ≥945 and ≤975 kg/m³ as determined in accordance with ASTM D792 (2008), preferably of ≥950 and ≤975 kg/m³, more preferably of >960 and ≤975 kg/m³, even more preferably of ≥965 and ≤975 kg/m³.

For example, the LLDPE may have a melt mass-flow rate of ≥0.5 and ≤5.0 g/10 min, preferably of ≥0.80 and ≤4.0 g/10 min, more preferably of ≥1.0 and ≤3.5 g/10 min, as determined in accordance with ASTM D1238 (2013) at a temperature of 190° C. under a load of 2.16 kg, and the HDPE may have a melt mass-flow rate of ≥3.0 and ≤15.0 g/10 min, as determined in accordance with ASTM D1238 (2013) at a temperature of 190° C. under a load of 2.16 kg, preferably of ≥3.0 and ≤12.0 g/10 min, more preferably of ≥5.0 and ≤12.0 g/10 min, even more preferably of ≥5.0 and ≤10.0 g/10 min.

The polymer formulation (A) may for example have
a density of ≥925 and ≤960 kg/m³, preferably of ≥925 and ≤950 kg/m³, more preferably of ≥930 and ≤950 kg/m³, as determined in accordance with ASTM D792 (2008); and/or
a melt mass-flow rate of ≥2.0 and ≤7.0 g/10 min, preferably of ≥2.0 and ≤5.0 g/10 min as determined in accordance with ASTM D1238 (2013) at a temperature of 190° C. under a load of 2.16 kg.

It is preferred that the linear low-density polyethylene is a copolymer comprising moieties derived from ethylene and moieties derived from one or more α-olefins selected from propylene, 1-butene, 4-methyl-1-pentene, 1-hexene, and 1-octene, preferably selected from 1-hexene and 1-octene, preferably from 1-hexene.

Particularly, it is preferred that he linear low-density polyethylene comprises at least 80.0 wt %, more preferably at least 85.0 wt % of moieties derived from ethylene, with regard to the total weight of the linear low-density polyethylene, preferably consists of at least 80.0 wt %, more preferably at least 85.0 wt % of moieties derived from ethylene, and moieties derived from 1-hexene. For example, the LLDPE may comprise ≥80.0 and ≤95.0 wt % of moieties derived from ethylene, more preferably ≥85.0 and ≤95.0 wt %. For example, the LLDPE may comprise ≥80.0 and ≤95.0 wt % of moieties derived from ethylene, more preferably ≥85.0 and ≤95.0 wt %, and moieties derived from 1-hexene. For example, the LLDPE may consist of ≥80.0 and ≤95.0 wt % of moieties derived from ethylene, more preferably ≥85.0 and ≤95.0 wt %, and moieties derived from 1-hexene.

For example, the LLDPE may comprise ≤20.0 wt %, preferably ≤15.0 wt % of moieties derived from 1-hexene, with regard to the total weight of the LLDPE. For example, the LLDPE may comprise moieties derived from ethylene and ≤20.0 wt %, preferably ≤15.0 wt % of moieties derived from 1-hexene. For example, the LLDPE may consist of moieties derived from ethylene and ≤20.0 wt %, preferably ≤15.0 wt % of moieties derived from 1-hexene.

For example, the LLDPE may comprise ≥5.0 and ≤20.0 wt %, preferably ≥5.0 and ≤15.0 wt % of moieties derived from 1-hexene, with regard to the total weight of the LLDPE. For example, the LLDPE may comprise moieties derived from ethylene and ≥5.0 and ≤20.0 wt %, preferably ≥5.0 and ≤15.0 wt % of moieties derived from 1-hexene. For example, the LLDPE may consist of moieties derived from ethylene and ≥5.0 and ≤20.0 wt %, preferably ≥5.0 and ≤15.0 wt %, of moieties derived from 1-hexene.

The comonomer content and the comonomer type may be determined by ¹³C NMR, such as on a Bruker Avance 500 spectrometer equipped with a cryogenically cooled probe head operating at 125° C., whereby the samples are dissolved at 130° C. in C₂D₂Cl₄ containing DBPC as stabiliser.

It is preferred that the high-density polyethylene is a homopolymer of ethylene.

The film may for example have a thickness of ≥5 μm and ≤200 μm, preferably ≥10 μm and ≤75 μm. The film may for example be a single-layer film or a multi-layer film, preferably the film is a multi-layer film having 3, 5, 7 or 9 layers. The film may for example comprise two outer layers and at least one inner layer, wherein at least one of the inner layer(s) is a layer consisting of the polymer formulation (A).

In a certain embodiment, the present invention also relates to a process for production of the film, wherein the process involves the steps in this order of:
(a) manufacturing an unoriented film via cast extrusion, the unoriented film comprising at least one layer consisting of a polymer formulation (A) comprising:
   ≥60.0 and ≤90.0 wt % of a linear low-density polyethylene; and
   ≥10.0 and ≤40.0 wt % of a high-density polyethylene
   with regard to the total weight of that layer of the film:
(b) subjecting the unoriented film to heat to bring the film to a temperature of >70° C. and <Tₚₘ of the linear low-density polyethylene, Tₚₘ being determined as peak melting temperature in accordance with ASTM D3418 (2008);
(c) stretching the heated cast film by:
   applying a stretching force in the machine direction (MD) to induce a drawing in the machine direction, and subsequently subjecting the obtained film to heat to bring the film to a temperature of between Tₚₘ−25° C. and Tₚₘ of the linear low-density polyethylene, under application of a stretching force in the transverse direction (TD) to induce a drawing in the transverse direction;
   or
      simultaneously applying a stretching force in the MD and the TD to induce a drawing in the MD and the TD;
(d) maintaining the stretching forces and temperature to ensure drawing in TD is maintained to a level of >85% of the drawing in TD as applied; and
(e) releasing the stretch force and cooling the stretched films to obtain a bi-directionally oriented film.

It is preferred that in the process, the degree of drawing in each of the MD and TD direction is at least 5.0, wherein the degree of drawing is the ratio between the dimension in the corresponding direction before and after the film is subjected to the orientation step in that particular direction.

The invention also relates to a package comprising the film, in particular to a package containing foodstuff products.

In an embodiment, the invention also relates to the use of a layer consisting of a polymer formulation (A) comprising:
≥60.0 and ≤90.0 wt % of a linear low-density polyethylene; and
≥10.0 and ≤40.0 wt % of a high-density polyethylene
in a bi-directionally oriented film comprising one of more layers, with regard to the total weight of that layer of the film, for improvement of the tensile modulus, in the MD and/or the TD direction, of the bi-directionally oriented film.

The invention will now be illustrated by the following non-limiting examples.

The following materials were used in the examples according to the present invention:

| | |
|---|---|
| LLDPE | SABIC LLDPE BX202, a linear low-density |
| | polyethylene obtainable from SABIC |
| HDPE | A high-density polyethylene homopolymer |
| | having properties as in the table below |

In the table below, key properties of the materials and of a formulation (I) comprising 80.0 wt % of the LLDPE and 20.0 wt % of the HDPE are presented.

| Material | LLDPE | HDPE | Formulation (I) |
|---|---|---|---|
| MFR2 | 2.1 | 8.0 | 3.4 |
| Density | 921 | 967 | 930 |
| Tₚₘ | 124 | 134 | 126 |
| T_{c} | 111 | 118 | 112 |
| Ethylene units content | 89.0 | 100.0 | 91.0 |
| Comonomer units content | 11.0 | — | 9.0 |
| Comonomer type | C6 | — | C6 |
| Comonomer branch content | 18.4 | — | |
| Mₙ | 18 | 11 | 16 |
| M_{w} | 109 | 72 | 102 |
| M_{z} | 463 | 324 | 440 |
| M_{w}/Mₙ | 6.0 | 6.3 | 6.2 |
| M_{z}/M_{w} | 4.2 | 4.5 | 4.4 |
| M_{z}/Mₙ | 25.4 | 28.4 | 27.2 |
| a-TREF <30 | 13.5 | 0.0 | 11.0 |
| a-TREF 30-94 | 50.9 | 0.0 | 41.0 |
| a-TREF >94 | 35.6 | 100.0 | 48.0 |
| Unsaturations | 160 | | |
| Storage modulus at loss | 3000 | 2400 | 2800 |
| modulus of 10.0 kPa | | | |
| Storage modulus at loss | 100 | 90 | 98 |
| modulus of 1.0 kPa | | | |

### Wherein:

the MFR2 is the melt mass flow rate as determined in accordance with ASTM D1238 (2013) at a temperature of 190° C. under a load of 2.16 kg, expressed in g/10 min;
the density is determined in accordance with ASTM D792 (2008), expressed in kg/m³;
Tₚₘ is the peak melting temperature as determined using differential scanning calorimetry (DSC) in accordance with ASTM D3418 (2008), expressed in ° C.;
T_{c} is the crystallisation temperature as determined using differential scanning calorimetry (DSC) in accordance with ASTM D3418 (2008), expressed in ° C.;
the ethylene units content indicates the weight quantity of units present in the polymer that are derived from ethylene, also referred to as the quantity of moieties derived from ethylene, with regard to the total weight of the polymer, expressed in wt %;
the comonomer content indicates the weight quantity of units present in the polymer that are derived from the comonomer, also referred to as the quantity of moieties derived from the comonomer, with regard to the total weight of the polymer, expressed in wt %;
the comonomer type indicates the type of comonomer used in the production of the polymer, where C6 is 1-hexene;
the comonomer branch content indicates the number of branches per 100 carbon atoms in the polymer, as determined via ¹³C-NMR;
Mₙ is the number average molecular weight, M_{w} is the weight average molecular weight, and M_{z} is the z-average molecular weight, wherein Mₙ, M_{w}, and M_{z} are each expressed in kg/mol, and determined in accordance with ASTM D6474 (2012);
a-TREF <30 indicates the fraction of the polymer that is eluted in a-TREF according to the method presented above in the temperature range ≤30.0° C., expressed in wt %, and represents the amorphous fraction of the polymer, calculated by subtracting the a-TREF 30-94 and the a-TREF >94 fraction from 100.0 wt %;
a-TREF 30-94 indicates the fraction of the polymer that is eluted in a-TREF in the temperature range of >30.0 and ≤94.0° C., expressed in wt %, and represents the branched fraction of the polymer;
a-TREF >94 indicates the fraction of the polymer that is eluted in a-TREF in the temperature range of >94.0 and <140° C., expressed in wt %, and represents the linear fraction of the polymer;
the unsaturations indicate the sum of vinyl unsaturations, vinylene unsaturations, vinylidene unsaturations, trialkyl unsaturations, and expressed in number of unsaturations per 1000000 chain carbon atoms, and are determined by ¹³C NMR on a Bruker Avance 500 spectrometer equipped with a cryogenically cooled probe head operating at 125° C., whereby the samples are dissolved at 130° C. in C₂D₂Cl₄ containing DBPC as stabiliser;
the storage modulus and the loss modulus are determined using dynamical mechanical spectroscopy (DMS) frequency sweep measurements according to ISO 6721-10 at a temperature of 190° C. in a nitrogen environment using a parallel plate set-up, using a frequency range of 0.1-100 rad/s, at oscillation strain of 5%, and are expressed in Pa.

The comonomer content and the comonomer type were determined by ¹³C NMR on a Bruker Avance 500 spectrometer equipped with a cryogenically cooled probe head operating at 125° C., whereby the samples are dissolved at 130° C. in C₂D₂Cl₄ containing DBPC as stabiliser.

The a-TREF analyses were carried out using a Polymer Char Crystaf TREF 300 device using a solution containing 4 mg/ml of sample in 1,2-dichlorobenzene stabilised with 1 g/l Topanol CA (1,1,3-tri(3-tert-butyl-4-hydroxy-6methylphenyl)butane) and 1 g/l Irgafos 168 (tri(2,4-di-tert-butylphenyl)phosphite) at a temperature of 150° C. for 1 hour. The solution was further stabilised for 45 minutes at 95° C. under continuous stirring at 200 rpm before analyses. For analyses, the solution was crystallised from 95° C. to 30° C. using a cooling rate of 0.1° C./min. Elution was performed with a heating rate of 1° C./min from 30° C. to 140° C. The set-up was cleaned at 150° C.

Using the above polymers, three-layer bi-directionally oriented films were produced. The bi-directionally oriented films were produced using a cast film production line with subsequent tenter frame type sequential biaxial orientation. A set-up comprising three melt extruders was used, where an extruder A supplied material for a first skin layer A, an extruder B supplied material for inner layer B, and an extruder C supplied the material for the second skin layer C. The extruders were positioned such that the molten material was forced through a t-shaped die with a die gap of 3.0 mm, so that the arrangement of the layers in the obtained cast film was A/B/C. Each of the extruders A, B and C was operated such to supply molten polymer material at a temperature of 250° C. The die temperature was 250° C. The throughput was 1000 kg/h.

The film as extruder through the t-shaped die was cast onto a chill roll to form a cast film having a thickness of about 840 μm.

The chilled cast film was subjected to stretching in the machine direction using a set of stretching rolls at a temperature of 98° C., followed by an annealing at 100° C., to induce a degree of stretching in the machine direction of 5.

Subsequently, the film was stretched in the transverse direction to a degree of stretching of 9.5 by subjecting the film to heat whilst applying a stretching force, wherein the film was passed through an oven through which the film was continuously transported, wherein the temperature was 140° C. at the entering zone of the oven, decreasing to 120° C. towards the exit of the oven. The skin layer A was subsequently subjected to a corona treatment of 25 W·min/m².

For each example, bi-directionally oriented 3-layer films having a thickness of 30 μm were obtained.

The composition of the experimental films is presented in the table below.

| | | | | Layer |
|---|---|---|---|---|
| | | | Layer | thick- |
| Example | Layer | Material composition | weight | ness |
| E1 | A | 97.0% LLDPE, 3.0% AB | 4.0 | 1.2 |
| | B | 80.0% LLDPE, 20.0 wt% HDPE | 92.0 | 27.6 |
| | C | 93.0% LLDPE, 2.0% AB, 5.0% SL | 4.0 | 1.2 |
| CE1 | A | 97.0% LLDPE, 3.0% AB | 4.0 | 1.2 |
| | B | 100.0% LLDPE | 92.0 | 27.6 |
| | C | 93.0% LLDPE, 2.0% AB, 5.0% SL | 4.0 | 1.2 |

Wherein the percentage in the material composition relates to the quantity of the particular material, in wt % with regard to the total weight of the material of that given layer, and wherein the layer weight indicates the percentage of the weight of the given layer with regard to the total weight of the given experimental film. The layer thickness is expressed in μm. In the above table, AB refers to anti-block agent CON-X AB 664 PE, obtainable from CONSTAB Polyolefin Additives GmbH, and SL refers to slip agent CON-X SL577 PE, obtainable from CONSTAB Polyolefin Additives GmbH. Example E1 is according to the invention, CE1 is comparative.

Of the thus obtained films, a set of properties were determined as indicated in the table below.

| Example | E1 | CE1 |
|---|---|---|
| Haze | 5.0 | 4.6 |
| Gloss | 87 | 85 |
| Dart impact | 460 | 480 |
| TM-MD | 640 | 480 |
| TM-TD | 1240 | 1010 |
| TS-MD | 76 | 70 |
| TS-TD | 190 | 180 |
| EL-MD | 280 | 240 |
| EL-TD | 40 | 40 |
| Thermal Shrinkage—MD | 2.1 | 3.8 |
| Thermal Shrinkage—TD | 3.5 | 4.5 |

### Wherein

Haze is determined in accordance with ASTM D1003 (2013), expressed in %;
Gloss is determined in accordance with ASTM D2457 (2013), at an angle of 45°, expressed in gloss units (GU);
Dart impact is determined as impact failure weight in accordance with ASTM D1709-09, method A, at room temperature, expressed in grams;
TM is the tensile modulus, determined in the machine direction (MD) and transverse direction (TD) of the film, expressed in MPa, determined as 1% secant modulus in accordance with ASTM D882-18, using an initial sample length of 250 mm and a testing speed of 25 mm/min, at room temperature, using preload of 1 N;
TS is the tensile strength at break as determined in accordance with ASTM D882-18, in both machine direction (MD) and in transverse direction (TD), expressed in MPa, determined at room temperature using an initial sample length of 50 mm and a testing speed of 500 mm/min;
EL is the elongation at break as determined in accordance with ASTM D882-18, in both machine direction (MD) and in transverse direction (TD), expressed in MPa, determined at room temperature using an initial sample length of 50 mm and a testing speed of 500 mm/min;
Thermal Shrinkage is measured according to ISO 11501 (1995) at a temperature of 100° C. for 5 minutes, in both MD and TD.

1. A film comprising one or more layers, wherein at least one layer consists of a polymer formulation (A) comprising:
(a) ≥60.0 and ≤90.0 wt % of a linear low-density polyethylene (LLDPE); and
(b) ≥10.0 and ≤40.0 wt % of a high-density polyethylene (HDPE)
with regard to the total weight of that layer of the film,
wherein the film is a bi-directionally oriented film wherein the orientation is introduced in the solid state.

2. The film according to claim 1, wherein the linear low-density polyethylene has:
a density of ≥910 and ≤930 kg/m³ as determined in accordance with ASTM D792 (2008);
a melt mass-flow rate of ≥0.5 and ≤5.0 g/10 min, as determined in accordance with ASTM D1238 (2013) at a temperature of 190° C. under a load of 2.16 kg;
a fraction that is eluted in analytical temperature rising elution fractionation (a-TREF) at a temperature ≤30.0° C. of ≥3.0 wt %, with regard to the total weight of the LLDPE; and/or
a fraction eluted in a-TREF at a temperature >94.0° C. of ≥20.0 wt %, with regard to the total weight of the LLDPE.

3. The film according to claim 1, wherein the high-density polyethylene has
a density of ≥945 and ≤975 kg/m³ as determined in accordance with ASTM D792 (2008); and/or
a melt mass-flow rate of ≥3.0 and ≤15.0 g/10 min, as determined in accordance with ASTM D1238 (2013) at a temperature of 190° C. under a load of 2.16 kg.

4. The film according to claim 1, wherein the polymer formulation (A) has
a density of ≥925 and ≤960 kg/m³ as determined in accordance with ASTM D792 (2008); and/or
a melt mass-flow rate of ≥2.0 and ≤7.0 g/10 min, as determined in accordance with ASTM D1238 (2013) at a temperature of 190° C. under a load of 2.16 kg.

5. The film according to claim 1, wherein the linear low-density polyethylene is a copolymer comprising moieties derived from ethylene and moieties derived from one or more α-olefins selected from propylene, 1-butene, 4-methyl-1-pentene, 1-hexene, or 1-octene.

6. The film according to claim 1, wherein the linear low-density polyethylene comprises at least 80.0 wt % of moieties derived from ethylene, with regard to the total weight of the linear low-density polyethylene.

7. The film according to claim 1, wherein the high-density polyethylene is a homopolymer of ethylene.

8. The film according to claim 1, wherein the film has a thickness of ≥5 μm and ≤200 μm.

9. The film according to claim 1, wherein the film is a single-layer film or a multi-layer film.

10. The film according to claim 9, wherein the film comprises two outer layers and at least one inner layer, wherein at least one of the inner layer(s) is a layer consisting of the polymer formulation (A).

11. A process for production of the film according to claim 1, wherein the process comprises the steps in an order of:
(a) manufacturing an unoriented film via cast extrusion, the unoriented film comprising at least one layer consisting of a polymer formulation (A) comprising:
≥60.0 and ≤90.0 wt % of a linear low-density polyethylene; and
≥10.0 and ≤40.0 wt % of a high-density polyethylene
with regard to the total weight of that layer of the film:
(b) subjecting the unoriented film to heat to bring the film to a temperature of >70° C. and <Tₚₘ of the linear low-density polyethylene, Tₚₘ being determined as peak melting temperature in accordance with ASTM D3418 (2008);
(c) stretching the heated cast film by:
applying a stretching force in a machine direction (MD) to induce a drawing in the machine direction, and subsequently subjecting the obtained film to heat to bring the film to a temperature between Tₚₘ−25° C. and Tₚₘ of the linear low-density polyethylene, under application of a stretching force in the transverse direction (TD) to induce a drawing in the transverse direction;
or
simultaneously applying a stretching force in the MD and the TD to induce a drawing in the MD and the TD;
(d) maintaining the stretching forces and temperature to ensure drawing in TD is maintained to a level of >85% of the drawing in TD as applied; and
(e) releasing the stretch forces and cooling the stretched films to obtain a bi-directionally oriented film.

12. The process according to claim 11, wherein a degree of drawing in each of the MD and TD direction is at least 5.0, wherein the degree of drawing is the ratio between the dimension in the corresponding direction before and after the film is subjected to the orientation step in that particular direction.

13. A package comprising the film according to claim 1.

14. The package according to claim 13 wherein the package contains foodstuff products.

15. (canceled)
